(19) United States
(12) Patent Application Publication
(10) Pub. No.: US 2018/0298922 A1
(43) Pub. Date: Oct. 18, 2018

(54) VALVE DEVICE

(71) Applicant: KYB Corporation, Tokyo (JP)

(72) Inventor: Akio MATSUURA, Kanagawa (JP)

(73) Assignee: KYB Corporation, Tokyo (JP)

(21) Appl. No.: 15/765,868

(22) PCT Filed: Sep. 8, 2016
(86) PCT No.: PCT/JP2016/076493

§ 371 Date: Apr. 4, 2018

(30) Foreign Application Priority Data
Oct. 16, 2015 (JP) 2015-204834

(51) Int. Cl. F15B 11/028; F15B 13/04

(52) U.S. Cl. CPC F15B 11/028; F15B 13/0417; F15B 2211/5158; F15B 2211/6054; F15B 2211/6355

(57) ABSTRACT

In a valve device, first and second spool holes in which first and second spools of first and second unload valves are accommodated, respectively, are formed in a second valve block, opening portions of the first and second spool holes are formed in surfaces in outer surfaces of the second valve block other than contact surfaces with adjacent first and third valve blocks and in parallel with axes of spools accommodated in the adjacent first and third valve blocks.

### TECHNICAL FIELD

The present invention relates to a valve device.

### BACKGROUND ART

JP2002-061602A describes a hydraulic control circuit (load sensing circuit) in which a control valve for controlling a work machine type actuator connected to each of a pair of variable displacement pumps and an unload valve is provided between the variable displacement pumps and the control valves, respectively.

This type of hydraulic control circuit is generally constituted by stacking valve blocks in which a control valve is assembled, respectively, and a valve block in which a pair of unload valves is assembled.

### SUMMARY OF INVENTION

When the pair of unload valves is assembled in the valve block, a shape of the valve block can be made symmetric and the pair of unload valves can be assembled from both side surfaces thereof.

In such constitution, first, the valve block is placed on a work table so that an opening of a spool hole formed in one of side surfaces is directed upward in order to assemble one of the unload valves in the valve block. Then, a spool of the one unload valve is inserted into the spool hole from an upper side toward the lower side of the spool hole.

After that, in order to assemble a spool of the other unload valve into the spool hole formed in the side surface on the opposite side (the other side), the valve block is inverted, and the opening of the spool hole on the opposite side is directed upward. Then, the spool of the other unload valve is inserted into the spool hole from the upper side toward the lower side of the spool hole.

In assembling the spools from both side surfaces of the valve block as described above, when the spool is to be assembled into the spool hole on the opposite side, the valve block needs to be inverted. Thus, a problem occurs that work efficiency of assembling of the spools becomes poor.

Thus, assembling of the pair of unload valves into the same side surface on the valve block can be considered. However, in this constitution, a passage communicating with each of the pair of unload valves needs to be provided on one side surface side of the valve block, and a problem occurs that a structure gets complicated.

An object of the present invention is to provide a valve device which can simplify passage constitution and has favorable assembling workability.

### BRIEF DESCRIPTION OF DRAWINGS

FIG. 1 is a sectional view of a fluid pressure control device to which a valve device according to an embodiment of the present invention is applied.

FIG. 2 is a sectional view of the valve device according to the embodiment of the present invention.

FIG. 3 is a circuit diagram of the fluid pressure control device to which the valve device according to the embodiment of the present invention is applied.

### DESCRIPTION OF EMBODIMENTS

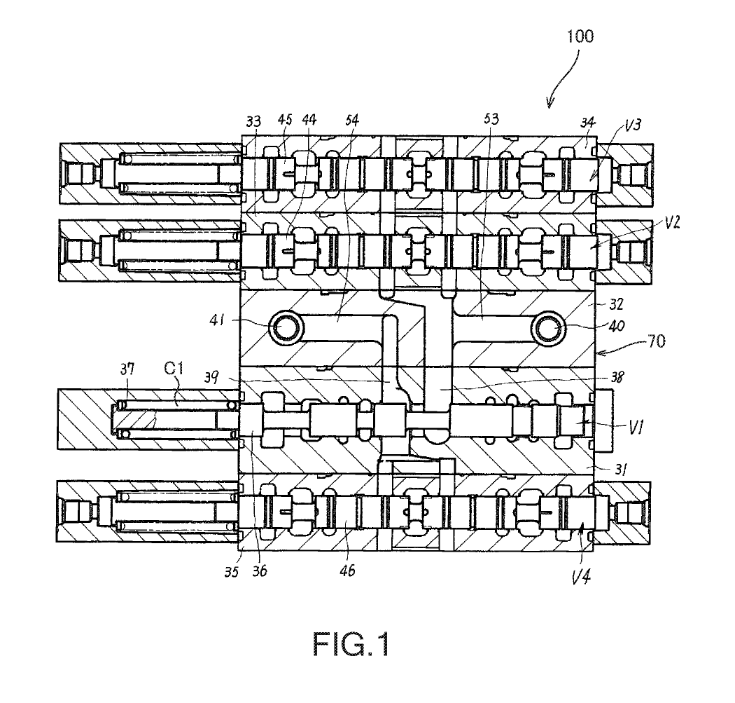

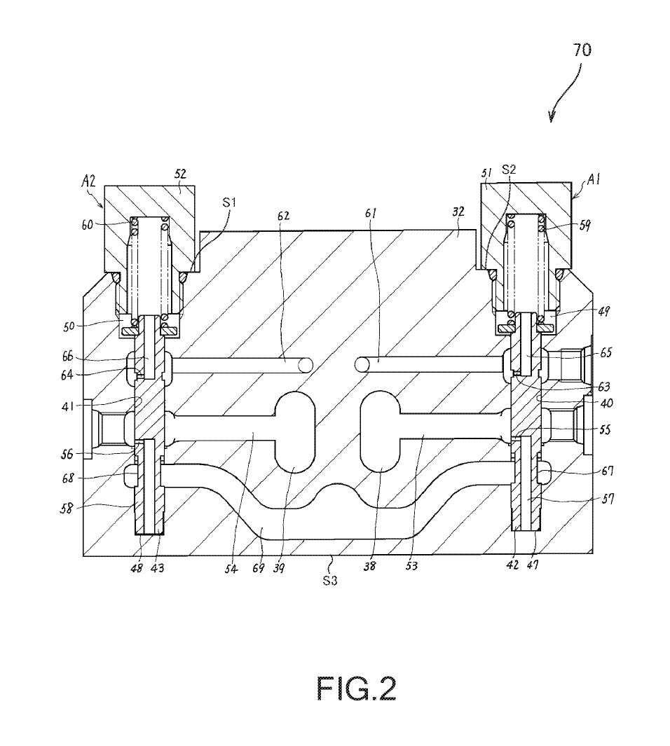

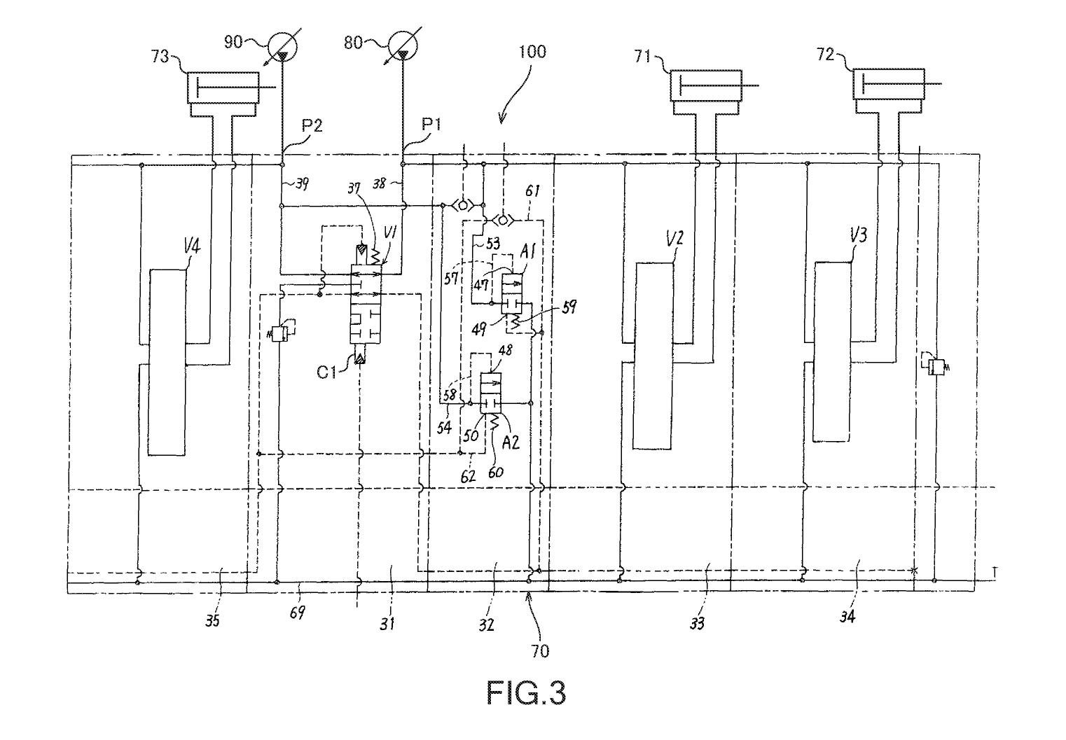

A valve device 70 according to an embodiment of the present invention will be described below by referring to the attached drawings. FIG. 1 illustrates a sectional view of a fluid pressure control device 100, and FIG. 2 illustrates a sectional view of a valve device 70. Moreover, FIG. 3 illustrates a circuit diagram of the fluid pressure control device 100. The fluid pressure control device 100 includes the valve device 70 and other control valves V2 to V4. In the valve device 70 and the fluid pressure control device 100, oil and other aqueous alternative fluid or the like are used as a working fluid.

As illustrated in FIG. 1, the fluid pressure control device 100 includes first to fifth valve blocks 31 to 35. The first to fifth valve blocks 31 to 35 are formed having a substantially cuboid shape, respectively. The fluid pressure control device 100 is constituted by stacking the first to fifth valve blocks 31 to 35. Other valve blocks, not shown, are stacked on a side surface of the fifth valve block 35 on a side opposite to the first valve block 31 and on a side surface of the fourth valve block 34 on a side opposite to the third valve block 33. The first valve block 31 is located substantially at a center in these valve blocks including these valve blocks, not shown.

As illustrated in FIG. 3, in the first valve block 31, first and second pump ports P1 and P2 connected to first and second pumps 80 and 90, respectively, first and second pump passages 38 and 39 communicating with the first and second pump ports P1 and P2, respectively, and a circuit switching valve V1 which will be described later are provided. Moreover, a spool 36 of the circuit switching valve V1 is slidably provided on the first valve block 31 (see FIG. 1).

The circuit switching valve V1 has a communication position (states in FIG. 1 and FIG. 3) allowing communication of the first and second pumps 80 and 90 and a shut-off position shutting off the communication of the first and second pumps 80 and 90. The spool 36 of the circuit switching valve V1 is biased by a spring 37 to the communication position. The circuit switching valve V1 is switched to the shut-off position against an biasing force of the spring 37 when a pilot pressure according to an operation of an operator from an outside is supplied to a pilot chamber C1.

When the spool 36 is at the communication position, the first pump passage 38 communicating with the first pump port P1 and the second pump passage 39 communicating with the second pump port P2 communicate with each other. Moreover, when the pilot pressure is supplied to the pilot chamber C1 and the spool 36 moves to a right direction in FIG. 1 against the biasing force of the spring 37, communication of the first and second pumps 38 and 39 is shut off.

Subsequently, the valve device 70 will be described.

The valve device 70 of this embodiment includes a second valve block 32 and first and second unload valves A1 and A2 accommodated in the second valve block 32. The second valve block 32 is stacked in a state sandwiched by the first and third valve blocks 31 and 33 as illustrated in FIG. 1.

As illustrated in FIG. 2, first and second spool holes 40 and 41 into which first and second spools 42 and 43 of the first and second unload valves A1 and A2 are slidably inserted, respectively, are formed in the second valve block 32.

Opening portions of the first and second spool holes 40 and 41 are formed in surfaces S1 and S2 in outer surfaces of the second valve block 32 other than contact surfaces with the adjacent first and third valve blocks 31 and 33 and in parallel with axes of the spools 36 and 44 accommodated in the first and third valve blocks 31 and 33. Specifically, the first and second spool holes 40 and 41 are opened in upper surfaces (surfaces S1 and S2) which are side surfaces different from the contact surfaces arranged in a direction where the second valve block 32 and the first and third to fifth valve blocks 31 and 33 to 35 are stacked and are formed from the upper surfaces (surfaces S1 and S2) toward a bottom surface S3 in a direction opposite to the upper surfaces (surfaces S1 and S2). The upper surface in this embodiment is a surface on the same side as a surface in which actuator ports (not shown) formed in the third to fifth valve blocks 33 to 35 and communicating with actuators which will be described later are opened. Moreover, the lower surface in this embodiment is a surface on a side opposite to the surface where the actuator port (not shown) is opened and is a mounting surface when the fluid pressure control device 100 is mounted on a base or a panel.

The first and second spool holes 40 and 41 only need to be opened in the upper surfaces (surfaces S1 and S2) of the second valve block 32 and they do not have to be perpendicular to the upper surfaces (surfaces S1 and S2). In this embodiment, the first and second spool holes 40 and 41 are provided in parallel with each other so as to extend perpendicular to the upper surfaces (surfaces Si and S2). By providing the first and second spool holes 40 and 41 in parallel with each other so as to extend perpendicular to the upper surfaces (surfaces S1 and S2) as described above, a tool can be set in the same direction when drilling them. Moreover, since a direction in which the first and second spools 42 and 43 are inserted can be made the same, a position of the second valve block 32 does not have to be inverted in a work process of assembling them.

In the embodiment illustrated in FIG. 2, the surfaces S1 and S2 are separated by a step, but they may be formed as one plane without providing the step. Moreover, the first and second spool holes 40 and 41 may be formed to be opened in the bottom surface S3.

When the first and second spools 42 and 43 are accommodated in the first and second spool holes 40 and 41, respectively, axes of the first and second spools 42 and 43 become substantially in parallel with the contact surfaces with the first and third valve blocks 31 and 33 adjacent to the second valve block 32 (see FIG. 1). Moreover, the axes of the first and second spools 42 and 43 are arranged in a perpendicular direction to an axis of the spool 36 of the circuit switching valve V1 assembled in the first valve block 31 and axes of the spools 44 to 46 of the control valves V2 to V4 assembled in the third to fifth valve blocks 33 to 35, that is, so as to be substantially orthogonal to the axes of the spools 44 to 46.

Subsequently, the control valves V2 to V4 will be described.

As illustrated in FIG. 3, the control valves V2 and V3 are assembled in the third and fourth valve blocks 33 and 34, respectively, and control actuators 71 and 72 driven by a working fluid discharged from the first pump 80. The control valve V4 is assembled in the fifth valve block 35 and controls an actuator 73 driven by the working fluid discharged from the second pump 90. The actuators 71 to 73 are reciprocating fluid pressure cylinder, fluid pressure motor and the like.

Subsequently, specific structures of the valve device 70 and the first and second unload valves A1 and A2 will be described by referring to FIGS. 2 and 3.

Regarding the first and second unload valves A1 and A2 provided in the second valve block 32, one ends of the first and second spools 42 and 43 are faced with first and second pump pressure introduction chambers 47 and 48, while the other ends are faced with first and second LS pressure introduction chambers 49 and 50 for introducing a load sensing pressure (hereinafter referred to as an “LS pressure”). The first and second LS pressure introduction chambers 49 and 50 are provided between the second valve block 32 and covers 51 and 52 attached to the second valve block 32, respectively. The load sensing pressure (LS pressure) in this embodiment is the highest load pressures of actuators 71, 72 and 73 controlled by the fluid pressure control device 100.

The valve device 70 further includes the first and second pump passages 38 and 39 connected to the first and second pumps 80 and 90, respectively, and first and second pump discharge fluid introduction passages 53 and 54 formed in the second valve block 32 and allowing the first and second pump passages 38 and 39 to communicate with the first and second spool holes 40 and 41, respectively.

A pump pressure of the first pump 80 is guided to the first pump pressure introduction chamber 47 through the first pump port P1, the first pump passage 38, and the first pump discharge fluid introduction passage 53. A pump pressure of the second pump 90 is guided to the second pump pressure introduction chamber 48 through the second pump port P2, the second pump passage 39, and the second pump discharge fluid introduction passage 54. The first and second pump passages 38 and 39 as well as the first and second pump discharge fluid introduction passages 53 and 54 are provided at substantially symmetric positions in the second valve block 32, respectively. Moreover, the second pump discharge fluid introduction passages 53 and 54 are provided so that lengths of the passages are substantially equal. By providing the passages at symmetric positions as above, the first pump passage 38 and the first pump discharge fluid introduction passage 53 do not interfere with the second pump passage 39 and the second pump discharge fluid introduction passage 54.

The first and second pump passages 38 and 39 are formed having substantially equal sectional areas so that pressure losses of the fluid passing them become substantially equal.

In the first and second spools 42 and 43, first and second communication holes 55 and 56 communicating with the first and second pump discharge fluid introduction passages 53 and 54 formed in the second valve block 32 at all times and first and second pump pressure introduction holes 57 and 58 formed along axes of the first and second spools 42 and 43 and allowing the first and second communication holes 55 and 56 and the first and second pump pressure introduction chambers 47 and 48 to communicate with each other, respectively, are formed. As a result, the pump pressures in the first pump port P1 and the second pump port P2 that have been guided into the first and second pump passages 38 and 39 are constantly guided to the first and second pump pressure introduction chambers 47 and 48 through the first and second pump discharge fluid introduction passages 53 and 54, the first and second communication holes 55 and 56, and the first and second pump pressure introduction holes 57 and 58, respectively.

Moreover, in the first and second LS pressure introduction chambers 49 and 50, springs 59 and 60 for biasing the other ends of the first and second spools 42 and 43 are provided, respectively. The springs 59 and 60 bias the first and second spools 42 and 43 so as to hold illustrated normal positions.

As illustrated in FIG. 2, first and second LS pressure introduction passages 61 and 62 for guiding the highest pressure of a load pressure of each of the actuators 71 to 73 are formed on the other end side (surface 51 and S2 sides) of the first and second spools 42 and 43 of the second valve block 32. The first and second LS pressure introduction passages 61 and 62 communicate with the first and second LS pressure introduction chambers 49 and 50 through the first and second communication holes 63 and 64 formed in the first and second spools 42 and 43 and first and second LS pressure introduction holes 65 and 66 formed along axes of the first and second spools 42 and 43.

Moreover, first and second annular grooves 67 and 68 are formed in the first and second spools 42 and 43. The first and second annular grooves 67 and 68 are provided so that, when the first and second spools 42 and 43 are at the illustrated normal positions, relative positions with respect to the first and second pump discharge fluid introduction passages 53 and 54 are shifted. As a result, when the first and second spools 42 and 43 are at the illustrated normal positions, communication between the first and second pump discharge fluid introduction passages 53 and 54 and a tank passage 69 by the first and second annular grooves 67 and 68 is shut off.

In the first and second unload valves A1 and A2 constituted as above, when pressures of the first and second pump pressure introduction chambers 47 and 48 become larger than a force totaling the LS pressures of the first and second LS pressure introduction chambers 49 and 50 and the biasing forces of the springs 59 and 60, respectively, the first and second spools 42 and 43 move against the biasing forces of the springs 59 and 60. Then, the first and second spools 42 and 43 are stopped at positions where those forces are balanced.

When the first and second spools 42 and 43 are at positions moved from the normal positions, the first and second pump discharge fluid introduction passages 53 and 54 communicate with the tank passage 69 through the first and second annular grooves 67 and 68. As a result, the working fluid discharged from the first and second pumps 80 and 90 is unloaded (returned) to the tank passage 69 through the first and second pump discharge fluid introduction passages 53 and 54 and the tank passage 69.

As illustrated in FIG. 2, the tank passage 69 is formed on a side of the first and second pump discharge fluid introduction passages 53 and 54 opposite to the opening portions of the first and second spool holes 40 and 41. Specifically, the tank passage 69 is provided on front in assembling directions of the first and second spools 42 and 43 with respect to the first and second pump discharge fluid introduction passages 53 and 54, that is, on the bottom surface S3 side of the second valve block 32. As a result, the tank passage 69 does not interfere with the first and second pump discharge fluid introduction passages 53 and 54.

Flow rates unloaded by the first and second unload valves A1 and A2 are determined by a lap amount between the first and second annular grooves 67 and 68 and the first and second pump discharge fluid introduction passages 53 and 54. In other words, the flow rate to be unloaded is determined in accordance with movement amounts of the first and second spools 42 and 43. Moreover, the working fluid flowing in through the first and second pump discharge fluid introduction passages 53 and 54 flows into the first and annular grooves 67 and 68 formed in the first and second spools 42 and 43 and flows out from there to the tank passage 69. Thus, a fluid force can be made smaller.

Moreover, since the first and second spool holes 40 and 41 formed in the second valve block 32 are formed so as to open in the same side surface side of the second valve block 32, the first and second spools 42 and 43 of the first and second unload valves A1 and A2 can be assembled to the second valve block 32 from the same direction. Therefore, the second valve block 32 does not have to be inverted in assembling works of the first and second unload valves A1 and A2.

Moreover, since the first and second pump discharge fluid introduction passages 53 and 54 are formed at substantially symmetric positions in right and left, the first and second pump discharge fluid introduction passages 53 and 54 do not interfere with each other, either.

Moreover, the tank passage 69 holds a positional relationship of a position not interfering with the first and second pump discharge fluid introduction passages 53 and 54 and extended between the first and second annular grooves 67 and 68 of the first and second unload valves A1 and A2. As a result, passage constitution in the second valve block 32 can be simplified.

Constitutions, operations, and effects of the embodiment of the present invention constituted as above will be described altogether.

The valve device 70 includes the valve block (second valve block 32) and the first and second unload valves A1 and A2 accommodated in the valve block (second valve block 32), the first and second spool holes 40 and 41 in which the spools (first and second spools 42 and 43) of the first and second unload valves A1 and A2 are assembled, respectively, are formed in the valve block (second valve block 32), and the opening portions of the first and second spool holes 40 and 41 are formed in the surfaces S1 and S2 which are surfaces in the outer surfaces of the valve block (second valve block 32) other than the contact surfaces with the adjacent valve blocks (first and third valve blocks 31 and 33) and are in parallel with the axes of the spools 36 and 44 accommodated in the adjacent valve blocks (first and third valve blocks 31 and 33).

According to this constitution, since the first and second spool holes 40 and 41 of the first and second unload valves A1 and A2 are formed in the surfaces 51 and S2 which are surfaces in the outer surfaces of the second valve block 32 other than the contact surfaces with the adjacent first and third valve blocks 31 and 33 and in parallel with the axes of the spools 36 and 44 accommodated in the adjacent first and third valve blocks 31 and 33, the first and second spools 42 and 43 can be accommodated in the first and second spool holes 40 and 41 from the same direction without inverting the valve block (second valve block 32). Moreover, the passage constitution in the second valve block 32 can be simplified.

Moreover, in the valve device 70, the first and second spool holes 40 and 41 are formed in directions perpendicular to the axes of the spools 36 and 44 accommodated in the adjacent valve blocks (first and third valve blocks 31 and 33).

In this constitution, since the first and second spool holes 40 and 41 are formed in parallel, a direction of a tool for performing drilling of the first and second spool holes 40 and 41 can be set in the same direction, and the directions in which the first and second spools 42 and 43 are inserted can be made the same.

Moreover, the valve device 70 includes the first and second pump passages 38 and 39 formed in the valve block (second valve block 32) and connected to the first and second pumps 80 and 90, respectively, and the first and second pump discharge fluid introduction passages 53 and 54 formed in the valve block (second valve block 32) and allowing the first and second pump passages 38 and 39 and the first and second spool holes 40 and 41 to communicate with each other, respectively, and the first and second pump discharge fluid introduction passages 53 and 54 are formed to have the equal lengths.

According to this constitution, the first pump passage 38 and the first pump discharge fluid introduction passage 53 do not interfere the second pump passage 39 and the second pump discharge fluid introduction passage 54.

Moreover, the valve device 70 further includes the tank passage 69 formed in the valve block (second valve block 32) and communicating with a tank T, and the tank passage 69 is formed on the side of the first and second pump discharge fluid introduction passages 53 and 54 opposite to the opening portions of the first and second spool holes 40 and 41.

According to this constitution, the first and second pump discharge fluid introduction passages 53 and 54 and the tank passage 69 do not interfere with each other any more.

Embodiments of this invention were described above, but the above embodiments are merely examples of applications of this invention, and the technical scope of this invention is not limited to the specific constitutions of the above embodiments.

The second valve block 32 may be constituted integrally with the first and third valve blocks 31 and 33, for example.

This application claims priority based on Japanese Patent Application No.2015-204834 filed with the Japan Patent Office on Oct. 16, 2015, the entire contents of which are incorporated into this specification.

1. A valve device comprising:
a valve block; and
first and second unload valves accommodated in the valve block, wherein
first and second spool holes in which spools of the first and second unload valves are accommodated, respectively, are formed in the valve block; and
opening portions of the first and second spool holes are formed in an outer surface of the valve block other than a contact surface with an adjacent valve block and in parallel with axes of a spool accommodated in the adjacent valve block.

2. The valve device according to claim 1, wherein
the first and second spool holes are formed in directions perpendicular to the axes of the spools accommodated in the adjacent valve blocks.

3. The valve device according to claim 1, further comprising:
a first pump passage formed in the valve block and connected to a first pump;
a second pump passage formed in the valve block and connected to a second pump;
a first pump discharge fluid introduction passage formed in the valve block and allowing the first pump passage and the first spool hole to communicate with each other; and
a second pump discharge fluid introduction passage formed in the valve block and allowing the second pump passage and the second spool hole to communicate with each other, wherein
the first and second pump discharge fluid introduction passages are formed to have equal lengths.

4. The valve device according to claim 3, further comprising:
a tank passage formed in the valve block and communicating with a tank, wherein
the tank passage is formed on a side of the first and second pump discharge fluid introduction passages opposite to the opening portions of the first and second spool holes.
